(19) United States
(12) Patent Application Publication
(10) Pub. No.: US 2006/0217823 A1
(43) Pub. Date: Sep. 28, 2006

(54) Software and hardware analysis test

(76) Inventor: John Edward Hussey, Placerville, CA (US)

Correspondence Address: Squire, Sanders & Dempsey L.L.P.;Two Renaissance Squire, Suite 2700, 40 North Central Avenue, Phoenix, AZ, 85004-4498, US

(21) Appl. No.: 11/384,205

(22) Filed: Mar. 17, 2006

Related U.S. Application Data
(60) Provisional application No. 60/663,037, filed on Mar. 17, 2005.

(51) Int. Cl. G05B 19/42

(52) U.S. Cl. 700/87

(57) ABSTRACT

Embodiments described herein relate to techniques, tools and processes for analyzing a computer system and determining the type and capabilities of hardware and software components resident on the computer system. This information can then be used for multiple different purposes. For example, the information may be used for (1) communicating an individual computer's ability to effectively operate a specific computer software and/or computer hardware product, (2) relaying the information to a technical support operation to allow a more rapid response, or (3) making a simple evaluation of the stand alone performance of a computer. These processes can be used for analyzing an individual computer's system inventory (computer hardware components and system software components) against a static set of manufacturer validated requirements for a hardware or software product.

### CROSS REFERENCE TO RELATED APPLICATION

This application claims the benefit of U.S. Provisional Application No. 60/663,037, filed Mar. 17, 2005, the contents of which are incorporated herein by reference.

### DESCRIPTION OF THE INVENTION

1. Field of the Invention

The present invention relates to a method, system, and computer program product for testing hardware and software, and more specifically to a method, system and computer program for analyzing system components of a computer to determine if predetermined system component requirements are met.

2. Background of the Invention

Computer hardware and software products have become increasingly more complex in terms of their features as well as their operational requirements. Often, publishers of software products and manufacturer's of hardware products provide a list of recommended hardware and software requirements that a user's computer should possess in order for the hardware or software product to function properly. Such hardware and software requirements are often presented as a list of minimum requirements for hardware and software components that should be resident on the user's computer.

However, understanding a computer's individual system components and capabilities is often difficult. A user may not even be aware of what hardware and software components reside on his computer. As such, trying to analyze those misunderstood or unknown individual system components against a list of requirements for a specific product is also often difficult.

Compounding the problem further is that most retailers will not accept computer software product returns if the CD packaging has been opened. So, if a user decides to purchase the product, installs the product on their computer, and finds it does not work, it is often the case that they will be unable to return the software products since it had been opened.

### SUMMARY OF THE INVENTION

In view of the foregoing, the invention provides a method, system and computer program for analyzing hardware and software components of a computer to determine if predetermined requirements are met.

Embodiments described herein relate to techniques, tools and processes for analyzing a computer system and determining the type and capabilities of hardware and software components resident on the computer system. This information can then be used for multiple different purposes. For example, the information may be used for (1) communicating an individual computer's ability to effectively operate a specific computer software and/or computer hardware product, (2) relaying the information to a technical support operation to allow a more rapid response, or (3) making a simple evaluation of the stand alone performance of a computer. These processes can be used for analyzing an individual computer's system inventory (computer hardware components and system software components) against a static set of manufacturer validated requirements for a hardware or software product. Other areas of the computer industry where these processes can be used include technical support, sales upgrades and taking inventory of computers remotely (asset management in an entity).

In summary, the described techniques and tools (1) facilitate the analysis of a computer's components and (2) compare the information obtained from the analysis of the components to a set of system requirements.

In one aspect, the invention provides a computer-executable method for analyzing hardware and software components of a computer. The method includes the steps of obtaining system component information regarding system components of a computer, comparing the obtained system component information to one or more system component requirements stored on a computer-readable medium, and determining if the system components of the computer meet the system component requirements based on the comparing step. In this way, the method facilitates the matching system component requirements (e.g., system requirements for a software product) with computer system components.

According to another aspect of the invention, the computer-executable method for analyzing hardware and software components of a computer may be in the form of a computer software program. This program may be resident on the computer to be analyzed or may be a software program downloaded for execution locally or run from a remote computer via a web interface. Likewise, the system component requirements may be obtained locally from the computer to be analyzed or over a network from a database or a computer-readable file.

According to another aspect of the invention, the system component requirements may include several requirement levels. These degrees of requirements may include a minimum requirement level, a recommended requirement level, and/or an optimum requirement level. As such, a user can then determine how well their own computer will operate a specific software application or hardware component compared to the system component requirements.

In another aspect of the invention, components of a computer's hardware and software are obtained and compared against a ranked list for each component. Each individual component of a computer is compared against each system component requirement and it is determined whether or not each specific component meets or exceeds the system component requirement, or whether or not that specific component was less than or lower than the system component requirement.

In another aspect, obtained information regarding a computer's system components are compared to system component requirements in aggregate. In this case, summary analysis may be provided to a user regarding their computer's ability to operate a specific software or hardware product having the system component requirements. In some cases a failure of only one individual requirement to meet the system component requirements will cause a summary failure (i.e., your computer can not run the specific product optimally). In some cases only certain component failures will cause a summary failure (e.g., your video card does not have Hardware Transform and Lighting so you cannot run this product).

In another aspect, when specific system components fail (e.g., your video card does not have enough RAM) the invention may provide methods to acquire appropriate computer hardware or software products to enable a user to solve the problem of operating a specific software or hardware product. In another aspect, when specific software components fail (e.g., your video card driver is not up to date), the analysis tool may provide methods to acquire software downloads, potentially for free, to enable that component to meet or exceed the system component requirements.

In another aspect, the analysis tool can display information (i.e. via a graphical user interface) to the user regarding their summary ranking (aggregate of individual component analysis) and individual component rankings compared to system component requirements. It is to be understood that the descriptions of this invention herein are exemplary and explanatory only and are not restrictive of the invention as claimed.

### BRIEF DESCRIPTION OF THE DRAWINGS

FIG. 1 is a flowchart showing the method steps according to one embodiment of the invention.

FIG. 2 is a flowchart showing the method steps according to one embodiment of the invention.

FIG. 3 is a flowchart showing the method steps according to one embodiment of the invention.

FIG. 4 is a flowchart showing the method steps according to one embodiment of the invention.

FIG. 5 is a schematic diagram of an illustrative network system in accordance with one embodiment.

FIG. 6 is a schematic diagram of a representative hardware environment in accordance with one embodiment.

FIG. 7 is an illustration example of the summary analysis that could be displayed to the user in the informing step of one embodiment of the invention.

FIG. 8 is an illustration example of the detailed individual component analysis for the manufacturer's validated MINIMUM system requirements displayed to the user in the informing step of one embodiment of the invention.

FIG. 9 is an illustration example of the detailed individual component analysis for the manufacturer's validated RECOMMENDED system requirements displayed to the user in the informing step of one embodiment of the invention.

FIG. 10 is an illustration example of the summary analysis that could be displayed to the user in the informing step according to one embodiment of the invention.

### DESCRIPTION OF THE EMBODIMENTS

Reference will now be made in detail to the present exemplary embodiments of the invention, examples of which are illustrated in the accompanying drawings.

The present invention relates to a method, system, and computer program product for testing hardware and software, and more specifically to a method, system and computer program for analyzing system components of a computer to determine if predetermined system component requirements are met.

For example, the methods of the invention help expedite the process of matching a manufacturer's system component requirement levels for a hardware or software product with an individual computer system's software and hardware components. The methods give users a result of whether or not their computer can run a specific software or hardware product, and if not, may also provide methods to upgrade, update, acquire or change their computer system to enable a positive result.

Consumers, hardware vendors, software vendors, and retailers may benefit from the present invention as it provides a person with any level of computer expertise a “piece of mind” before buying computer software and hardware. The described methods help consumers by, for example, giving them a level of comfort that their computer can operate a product before they purchase that product.

Consumers can also use these techniques and tools to determine if their computer system is not powerful enough to run current applications in the market or if their computer system only needs a few component upgrades. For example, many software applications in the game sector require more power (for example, faster CPU, more RAM, more powerful video card), from their computer. On the other hand, many productivity applications (e.g., word processors) do not need the same level of computer power. Users can make decision regarding upgrading or purchasing a new computer based on the type of applications they want to operate.

Software publishers, hardware component manufacturers and retailers may benefit from the described methods by; for example, reducing expensive product returns from consumers whose current computers did not meet the minimum manufacturer's system component requirement.

Furthermore, software publishers and hardware component manufacturers can use these tools and techniques to help quickly evaluate and solve technical support queries and questions from consumers. For example, when a consumer calls or emails technical support regarding a problem with their purchased software, the first question asked of consumers regards the inventory of their individual computer. Many users do not know their system inventory; many have trouble accumulating all that data at one time, and/or become intimidated at running the current tools that exist in the marketplace. The described methods provide an easier and more useful method for communicating the appropriate information from the user to the technical support technician.

The methods of the invention may also be used as a gift-giving helper. This invention could be very helpful to both the giver and the recipient in that potentially neither party may know what products could operate correctly on the recipient's computer or device. For example a user could launch a “gift-giving helper” on a website and email a link to the designated recipient. The designated recipient would receive an email from the potential gift-giver explaining that the gift-giver wants to give a gift to the gift-recipient but needs to know information about the recipient's computer so they can give them a gift that works. The recipient could click on a specific link in the email that takes them to a web site and performs a system inventory and obtains system component information concerning the system components of their computer or device. The recipient's system component information can then be used by the gift-giver to analyze a group of products (i.e. children's PC games for a specific age group) so that they can select an appropriate gift that will operate on the recipient's computer.

Accordingly, the described methods allow consumers a quicker and easier method for evaluating whether or not a specific software or hardware component can operate on their computer. The described methods, individually or in combination, include (but are not limited to) the following features:
1. Analysis tools for obtaining system component information from a computer
2. Predetermined and validated manufacturer's system component requirements
3. Standardized ranking presentation for hardware (systems and components)
4. Standardized ranking presentation for software

The analysis methods of the invention facilitate gathering system component information of a computer and comparing that information against system component requirements.

The embodiments set forth herein can be described in the general context of any computer-readable media. Computer-readable media are any available media that can be accessed within any computing environment.

The embodiments set forth herein can also be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

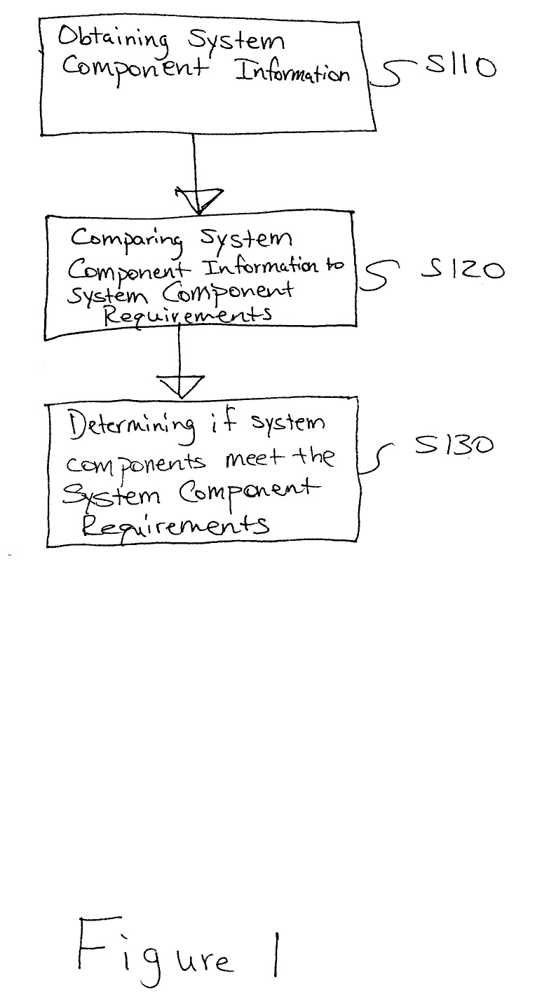

FIG. 1 shows the method steps according to one embodiment of the invention. In step S110, system component information regarding system components of a computer are obtained. In step S120, the obtained system component information is compared to one or more system component requirements stored on a computer-readable medium. In step S130, based on the comparison, it is determined if the obtained system components of the computer meet the system component requirements.

In step S110, system component information concerning the system components of a computer are obtained. The system components of a computer may include any hardware component of a computer (e.g., system RAM, CPU, CPU speed, video card name, video card chipset, video card RAM, video card features such as 3D capability, hardware transform & lighting, pixel shader version, vertex shader version, video card driver, maximum color depth, maximum resolution, BIOS versions, USB ports & versions, graphic port type, Internet connectivity & speed, sound card, I/O ports, etc.) and/or any software components of a computer (e.g., device drivers, software applications, operating systems, etc.).

The obtained system component information may be any information concerning the system components that would be useful in determining if the system components meet a set of system component requirements. Preferably, the system component information is in the form of the name of the component and/or the features of the component. The name of the component may be in the form of a serial number, model number, product name, manufacturer's internal name, or any combination thereof. The features of a component may include characteristics or capabilities of a component. For example, the features of CPU may include processor speed, expansion slots, communication bus types, etc. For a video card, examples of information (features and names) may include chipset name, amount of video RAM, 3D capabilities, rasterization capabilities, pixel shader version, vertex shader version, hardware transform & lighting capabilities, driver version, port interface and speed (PCI, AGP, PCI Express x16).

The system component information may be obtained using any computer-executable techniques for querying the inventory of hardware and/or software components of a computer and obtaining the names and/or features of the inventoried components. Such analysis tools for obtaining system component information may include Microsoft's DirectX Diagnostics (DXDiag), Microsoft's DirectX, Windows Device Manager, Windows System Registry, Windows Management Instrumentation (WMI), Windows Application Program Interface (Windows API), Device Drivers or other tools to perform or assist in performing certain functions, such as taking inventory of components or component features. All of these tools gather information concerning the system inventory (i.e., the system components).

The invention may make an analysis regarding the appropriate inventory of system components to display and analyze. In some cases, the tools listed above may provide different information regarding an individual component. In that case, the invention analyzes the received information to determine the appropriate component information to display and analyze. For example, a user could have upgraded their video card but not installed it correctly. Or the user may have installed a second video card on their system. When both video cards are detected on the computer, this invention analyzes which video card is better and uses that component information for display and analysis.

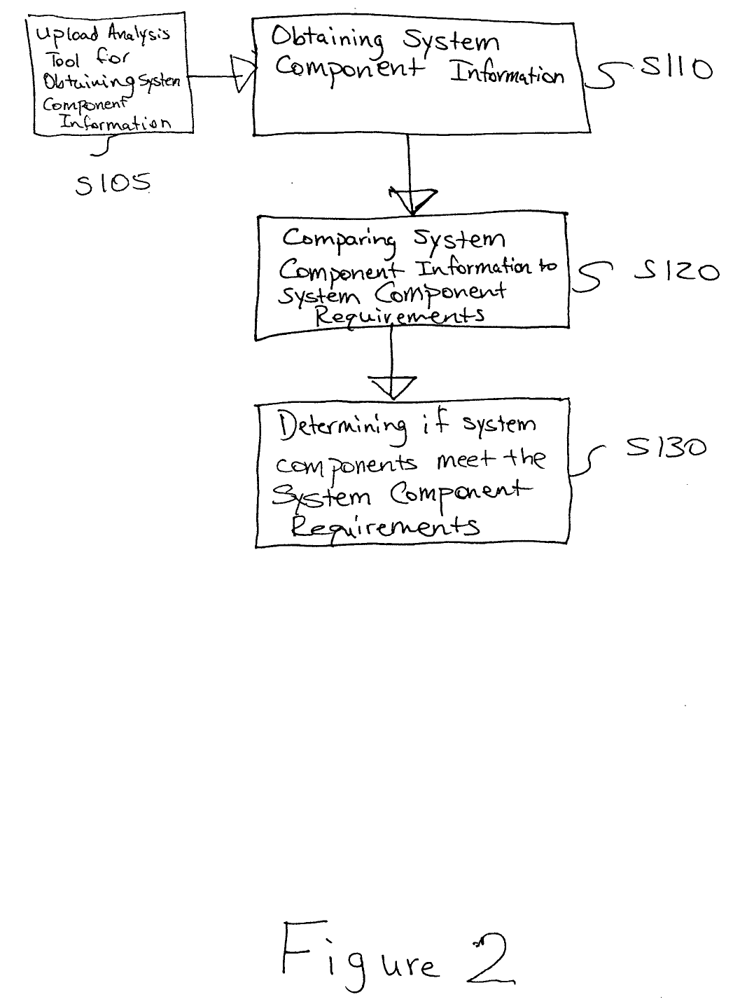

A computer user may access such analysis tool for obtaining system component information from a variety of computing devices and from a variety of sources. In some cases an analysis tool may be uploaded to a user's computer from a network via a wired connection (e.g. telephone line, DSL, cable modem or other wired connection), or a wireless connection, or by installing from a CD or other media. FIG. 2 shows the method steps of the invention with the additional step S105 of uploading an analysis tool to a computer. In other instances, the analysis tool may be resident on a networked computer, such as a web server, and executed remotely to obtain system component information from a user's computer.

As one example, a user may wish to analyze a computer's system components when purchasing a hardware or software product on an Internet retail site. In such a case, a user selects a specific product on a computer they desire to analyze. The choice may be made from a variety of options including picking from a list of products, clicking a button on a product specific page, typing in a product name in a text box, etc. Once the choice is made, an analysis tool (either uploaded by the Internet site or already resident on the user's computer) retrieves the computer's inventory of system components and obtains the system component information for each system. This system component information may then be compared to system component requirements for the desired hardware or software product. These system component requirements are stored on a computer-readable medium, either on the user's computer or at another remote site. As such, the comparison may take place on the user's computer or at a remote site (e.g., the Internet retail site). The comparison step is discussed in more detail below.

In some cases the analysis tool used in the obtaining step may not be able to discern information concerning a specific component from an individual's computer. In these cases, the tool may communicate such a failure to the user. In other cases, the analysis tool used in the obtaining step may not be able to ascertain information concerning a specific component which may prevent a comparison of the system component information to the system component requirements (e.g., could not detect how much RAM your video card has so a proper comparison of your system component information to system component requirements can not be performed).

In step S120, the obtained system component information is compared to one or more system component requirements stored on a computer-readable medium, and then in step S130, based on the comparison, it is determined if the obtained system components of the computer meet the system component requirements.

The system component requirements are any set of requirements that need to be met for a computer to operate and/or use a hardware or software product. Typically, such requirements are set by the manufacture or publisher of hardware and/or software products in the form of a list of minimum system components a computer must have. Such requirements may be listed in terms of a name (e.g., brand) of component that a computer must have (e.g., Microsoft Windows XP for an operating system, NVIDIA branded GeForce3 video card chipset or higher with Pixel Shader 1.1) or features (e.g., capabilities) that system components of the computer must have (e.g., >256 MB RAM, >1.8 GHz processor speed).

In order to facilitate easier comparison, the system component requirements for a specific hardware or software product or groups of hardware or software products are stored on a computer-readable medium. Before storing on a computer-readable medium, it is preferable to validate the accuracy the manufacturer's system component requirements and arrange them in a manner that affords easier comparison to obtained system component information.

For example, if a manufacturer's system component requirement is in the form of a list of names and/or features of components that are suitable, the stored system component requirements may be in the form of a list of the names and/or features of all or the most commonly-utilized system components that do and do not pass. As such, obtained system component information in the form of a name may be compared to each list. If the information for a specific system component is found in the pass list in the comparison step (S120) it is determined (S130) that the associated system component of the computer meets the manufacture's requirements. Conversely, if the information for a specific system component is not found in the pass list (or is found on a not pass list) in the comparison step (S120) it is determined (S130) that the associated system component of the computer meets the manufacture's requirements.

As another example, for system component requirements that call for a system component feature in the form of number, a simple comparison of the obtained system component information may be made to the numerical system component requirement.

Each individual piece of component information is compared against the stored system component requirements for that type of component (for example the CPU static list could include Pentium, Pentium II, Pentium III, Pentium 4, etc.). If the component is determined to meet or exceed the corresponding system component requirement, that component passes. If the component is determined to be less than the system component requirement, that component fails. All individual components that have a corresponding system component requirement are analyzed and results may be provided for the user. Preferably, if any one of the components fails to meet a requirement, it will trigger an overall failure for that manufacturer validated requirement level.

In addition to comparing individual pieces of system component information to each system component requirement of corresponding type, it is possible to compare an aggregate of system computer information to an aggregate system component requirement. That is, a computer may have components that individually fail a set of system component requirements, but may still be operationally able to utilize the hardware or software product due to the combination of components resident on the computer. In this case, in addition to or instead of having system component requirements stored as individual component requirements, they are stored as different groupings of component names and features that would meet the manufacturer's requirement for operating the hardware or software product.

System component requirements are not limited to minimum requirements, but rather may include several degrees to which a computer's system components may be categorized. For example, the requirements may include a minimum requirement degree, a recommended requirement degree, an optimal requirement degree, and/or a 3D requirement degree (e.g., some video games may be played in a lower-resolution ‘normal’ mode or a higher resolution ‘3-D’ mode). As such, the comparison and determining steps may also be configured to not only determine if the system components of a computer pass certain system component requirements, but may also determine to what degree the system components of the computer pass or do not pass.

In such a situation, the system component requirements may be stored categorically. That is, names and/or features of components may be arranged in categories such as fail, meets minimum requirements, meets recommend requirements, etc. In this case, the comparing step determines what category the obtained component system information matches in the system component requirements. In addition, the system component requirements may be arranged as a ranked list with demarcations showing at which level a system component does or does not pass.

In some situations, a component requirement will name a specific brand and model as a specific system component requirement (for example—video card chipset of NVIDIA GeForce3 or better). Preferably, the described methods analyze the computer video card to facilitate comparing the video card name based on a set categorization of the popular video card manufacturers. But in the case of a video card name information that is obtained that cannot be ranked because it is an off-brand, the invention may further utilize feature information of the video card (for example hardware transform & lighting, pixel & vertex shader versions) and compare the features of the off-brand video card to stored features of popular brand video cards that meet the system component requirements.

Rather than comparing the obtained system component information to system components to one hardware or software product, the invention is also applicable to comparing the obtained system component information to system component requirements for a group of one or more software and hardware products. For example, this invention could be used to analyze a user's computer against a list of top 10 PC products. This situation would benefit the user by showing them what products out of a group of products they could operate on their computer. The opposite situation would be to show to the user that they need to upgrade their computer if they want to run any of the latest and greatest software products.

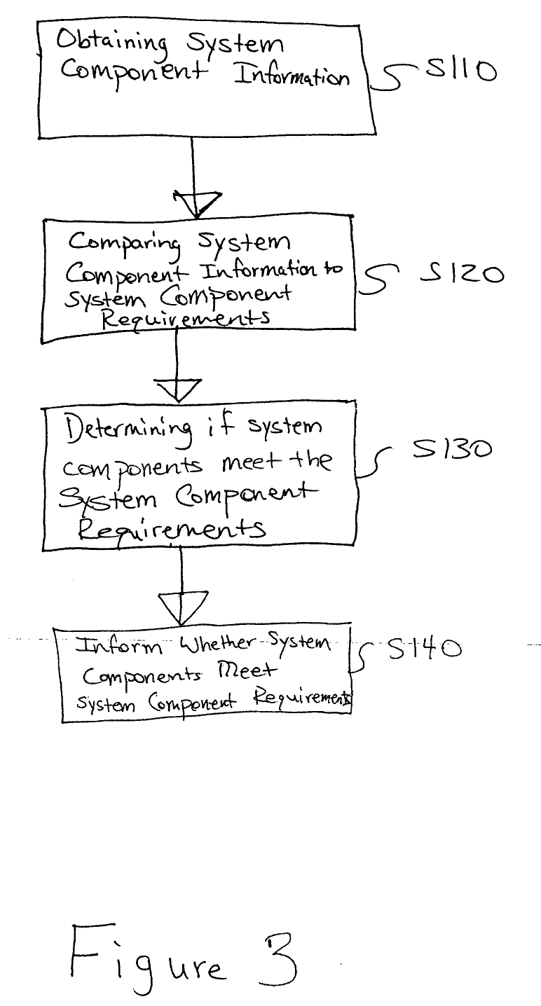

As shown in FIG. 3, the method may further include the step S140 of informing of a degree to which the obtained system components of the computer meet the system component requirements based on the determining step. A user of the invention may be informed in any manner, but is preferably informed via the graphical user interface of the computer that is being analyzed. A user may be informed of whether his computer meets or does not meet the requirement of a specific hardware or software product, what components failed and passed, and to what degree the computer or a component of a computer passed if there is more than two degrees (e.g., fail, meets minimum requirements, meets recommended requirements).

In some situations a specific manufacturer's validated requirement may not be specific enough. This informing step may still provide an overall summary analysis to the consumer when those specific requirements are incomplete. For example, Intel's processor family named Celeron does not have a ranking like the Pentium family. However, Celerons have increased in CPU Speed. Most manufacturer's validated requirement list the Pentium family (I, II, III, or 4) as a requirement linked to CPU speed. However, there are many Celeron family processors in the market with high speeds as well. When the analysis tool obtains component information for a Celeron or Duron processor, it may automatically link the CPU Speed and CPU together to form one single requirement for overall summary analysis purpose. Another example would be the analysis of lower powered video cards (i.e. integrated video cards which are normally less powerful than discrete video cards). In certain situations, the comparing and determining steps may provide a PASS for a lower powered video card if the CPU has an adequately fast speed to operate the desired hardware or software product.

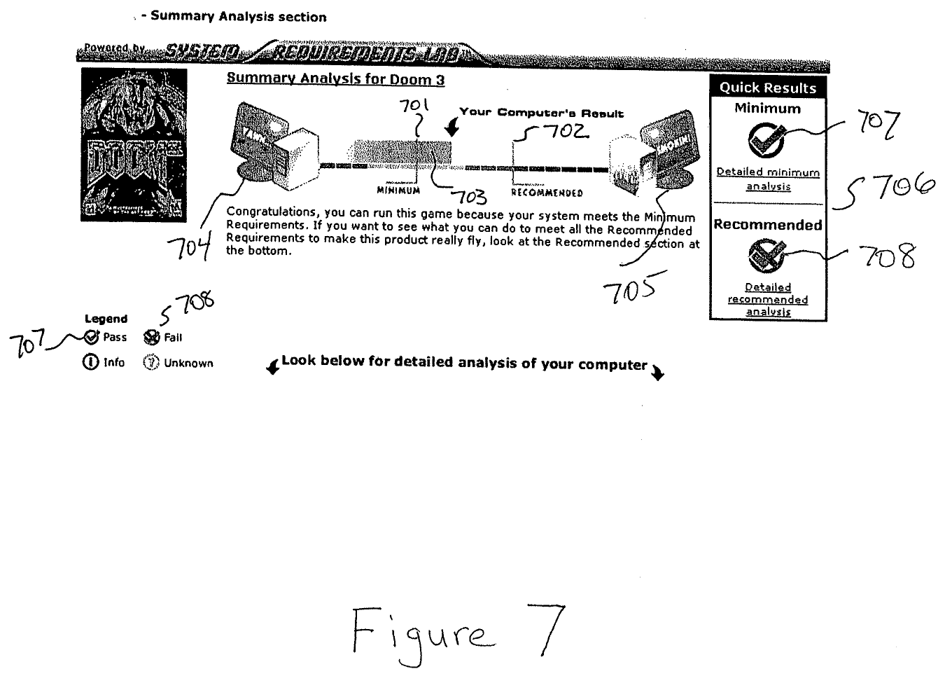

FIG. 7 is an illustration example of the summary analysis that could be displayed to the user regarding whether or not their computer can run a specific product. In this example the analysis shows a user passes the minimum requirements 701 (the computer can operate the Doom 3 product), but does not pass the recommended requirements 702. As shown, the summary analysis can show the user a graphical description of how their computer meets, does not meet, or exceeds a specific requirement level. FIG. 7 shows an example of a linear representation 703 of a computer that passes the minimum requirement because the thick horizontal bar begins at the slow end of the spectrum 704 (“Yawn computer”) and extends further than the “Minimum” vertical bar 701. But the thick bar does not reach the “Recommended” vertical bar 702 nearer the fast end of the spectrum 705 (“Smokin” Computer”). Also represented in FIG. 7 is a quick snapshot 706 of each requirement level (in this case “Minimum” and “Recommended”) and either a check mark 707 (representing a PASS of that specific requirement level) or a Don't Pass mark 708 (representing a FAIL or that specific requirement level).

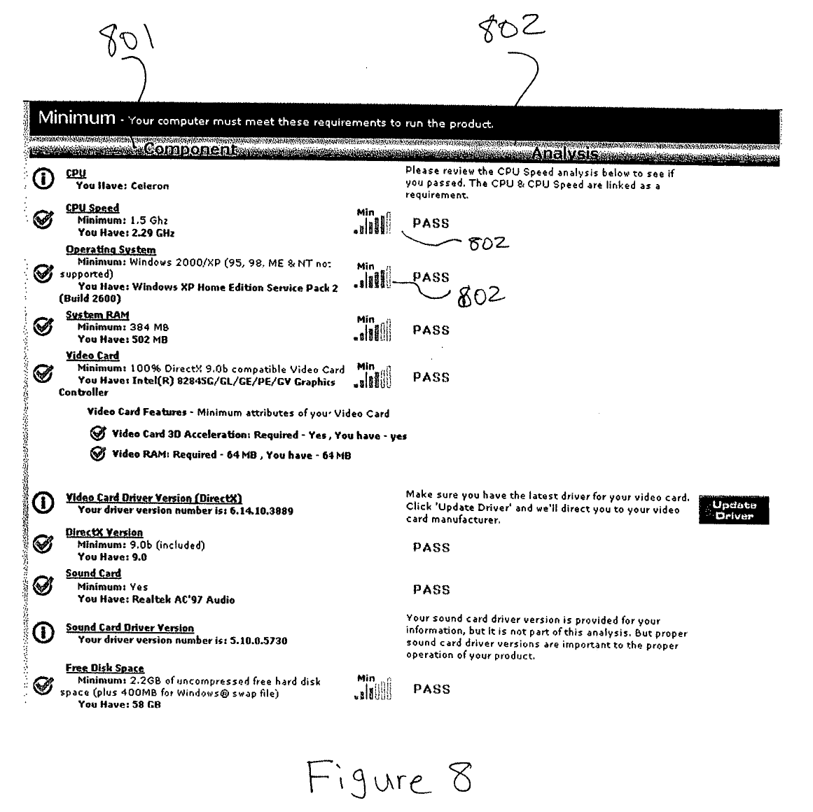

FIG. 8 is an illustration example of the detailed individual system component analysis for the manufacturer's validated MINIMUM system requirements that may be displayed in the informing step. In this example the analysis shows a user's computer passes the minimum requirements (i.e., the computer can operate the Doom 3 product). In this example each individual component requirement 801 has its own row. Each row has a graphical representation 802 of a PASS, FAIL, INFORMATION, or Don't Know. The row also has a description of the individual component (i.e. CPU), what the manufacturers validated requirement is (“Minimum”), what the analysis tool has detected on the computer (“You Have”), a component chart to show graphically how that specific component ranks according to the requirement, a text description of that specific component Passing, Failing, Information or Don't know, and if the specific component failed to meet the requirement, a potential solution can be provided so the user can meet that specific requirement. In this example Information rows are also provided for Driver version numbers (Video Card & Sound Card). Although an information row is not part of the analysis regarding whether or not a computer passes or fails a specific requirement level, it can be very informative to users and technical support representatives.

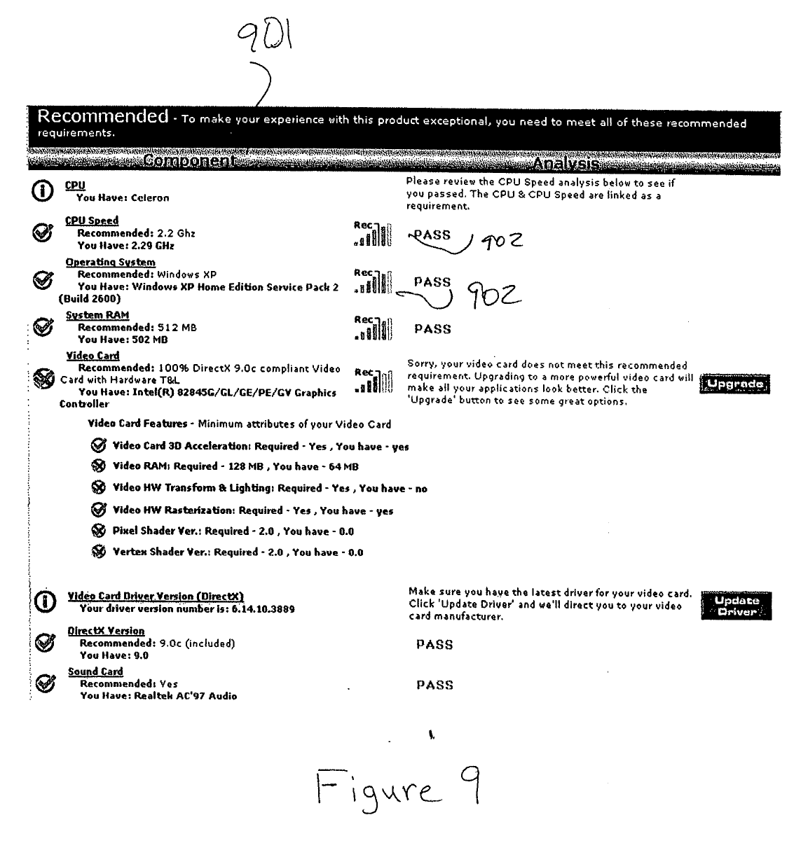

FIG. 9 is an illustration example of the detailed individual component analysis for the manufacturer's validated RECOMMENDED system requirements. In this example the analysis shows a user fails the recommended requirements (the computer will not operate Doom 3 under the manufacturer's validated RECOMMENDED requirements). In this example each individual component requirement 901 has its own row. Each row has a graphical representation 902 of a PASS, FAIL, INFORMATION, or Don't Know. The row also has a description of the individual component (i.e. CPU), what the manufacturers validated requirement is (“Recommended”), what the analysis tool has detected on the computer (“You Have”), a component chart to show graphically how that specific component ranks according to the requirement, a text description of that specific component Passing, Failing, Information or Don't know, and if the specific component failed to meet the requirement, a potential solution can be provided so the user can meet that specific requirement. In this example Information rows are also provided for Driver version numbers (Video Card & Sound Card). Although an information row is not part of the analysis regarding whether or not a computer passes or fails a specific requirement level, it can be very informative to users and technical support representatives.

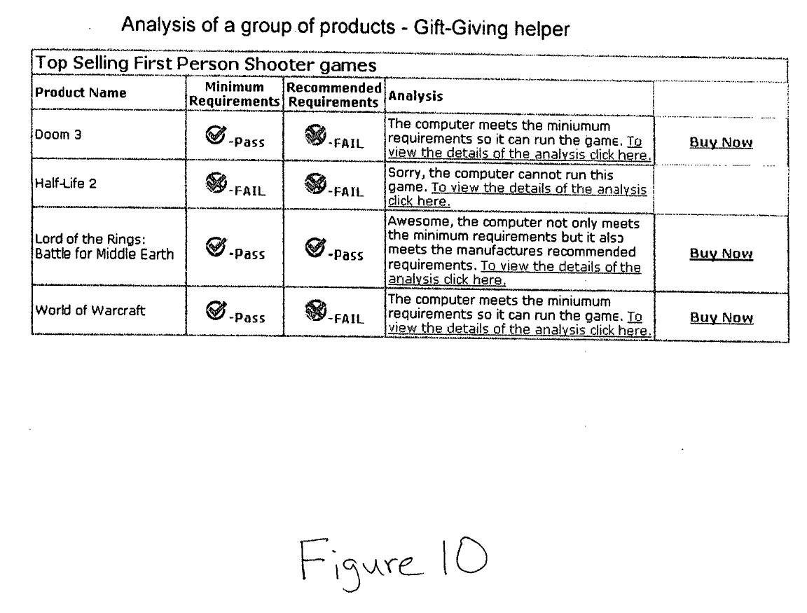

FIG. 10 is an illustration example of the summary analysis that could be displayed to the user regarding whether or not their computer or another person's computer can operate individual product in a specified group. This example shows how this invention could be used to facilitate the analysis of a specific computer compare to a group of products.

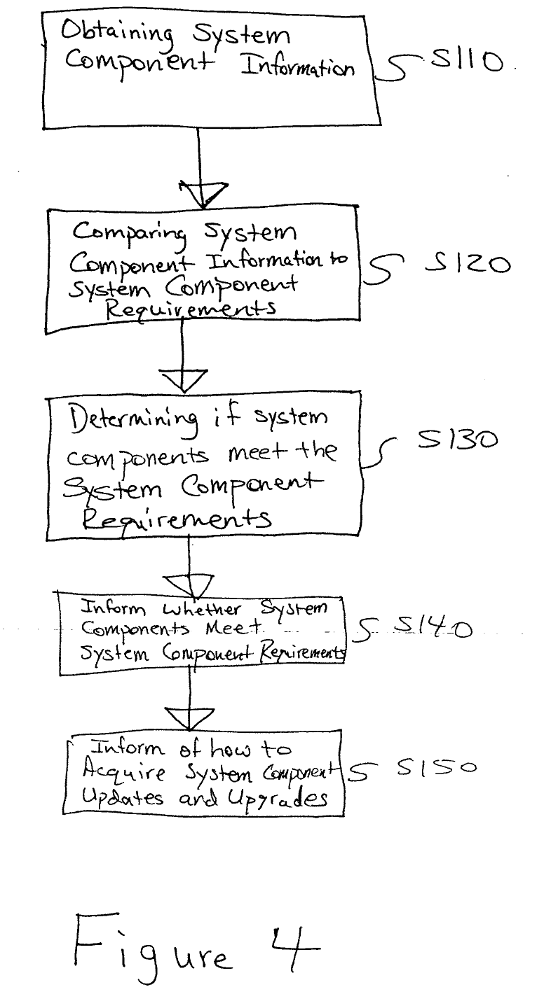

As shown in FIG. 4, the invention may include an additional step S150 of informing of how to acquire system component and upgrades in the case that a component does not meet a minimum and/or recommended requirement. For example if a consumers video card has only 16 MB of RAM, but the system component requirement states 32 MB of RAM, the informing step may display a method, (web link, product list to print out, array of solutions) for the consumer to acquire the appropriate product.

Similarly, in some situations, when a specific component of the consumer's computer does not meet the manufacturer's validated requirement, a recommendation (see “Recommendation” button in FIG. 8) is made to the consumer on what they can purchase to make their computer meet or exceed the specific manufacturer's validated requirement. This recommendation may be based on multiple component requirements. For example, if the manufacturer's validated requirement for the computer's Central Processing Unit (CPU) is not met, the informing step S150 may provide the consumer with a recommendation on what computer can be purchased to meet or exceed the requirement. However, recommendations on purchasing an entirely new computer also takes into account the entire manufacturer's validated requirements and not just the CPU. As such, the informing step 150 considers all of the manufacturer's validated requirements and recommends a new computer that meets all of the manufacturer's validated requirements for that product.

In some situations, when the analysis tool shows that a computer does not meet the manufacturer's validated requirements for a specific product, the informing step S150 may provide a list of all appropriate and/or similar hardware or software products with system component requirements that are met by consumer's computer configuration. Appropriate products may be based on the referring site, meaning where the analysis tool is launched from. For example, if one publisher runs the analysis tool from their site, the appropriate products would be only that publisher's products. Appropriate products may also be based on the genre of the products being evaluated, the ESRB rating of the product being evaluated, or may be products listed that have paid to be listed.

In addition, in some situations the analysis and comparison of the manufacturers validated requirements to a user's computer does not always give enough detail based on the user's computer. In this case, the informing step S150 may provide appropriate information and appropriate solutions to the consumer. For example, a manufacturer's validated requirement for a video card may be 16 MB 3D enabled video card. However, since there are different types of connections for video card ports (ports that video cards plug into—PCI, AGP, PCI Express), the consumer may not know which type of video card to purchase. The analysis tool can also gather the specific user's video card port information (PCI, AGP, PCI Express) and the informing step may then provide information concerning an appropriate video card to purchase based on their this obtained port information.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

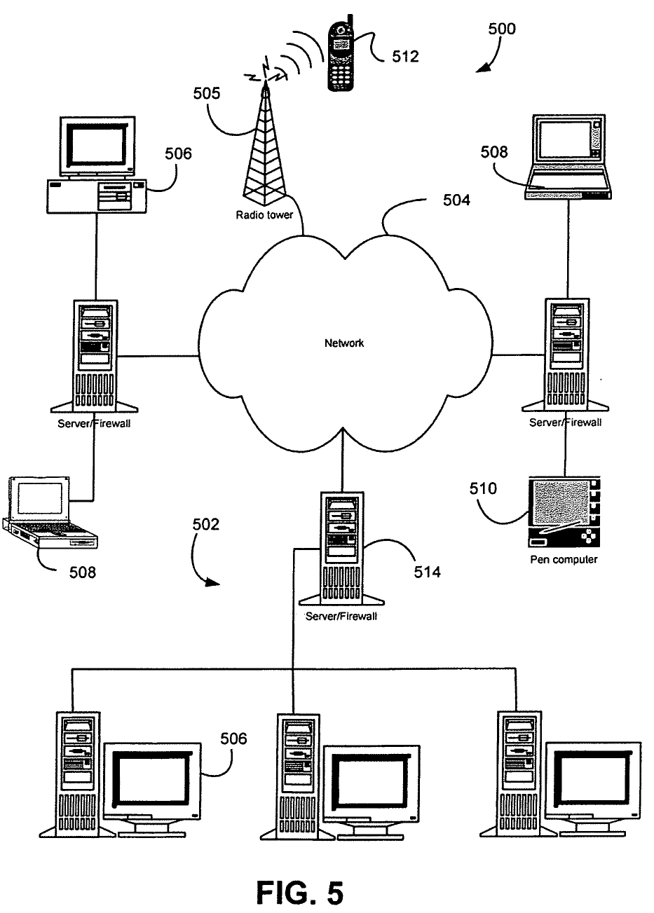

FIG. 5 illustrates an exemplary network system 500 with a plurality of components 502 in accordance with one embodiment. As shown, such components include a network 504 which take any form including, but not limited to a local area network, a wide area network such as the Internet, and a wireless network 505. Coupled to the network 504 is a plurality of computers which may take the form of desktop computers 506, lap-top computers 508, hand-held computers 510 (including wireless devices 512 such as wireless PDA's or mobile phones), or any other type of computing hardware/software. As an option, the various computers may be connected to the network 504 by way of a server 514 which may be equipped with a firewall for security purposes. It should be noted that any other type of hardware or software may be included in the system and be considered a component thereof.

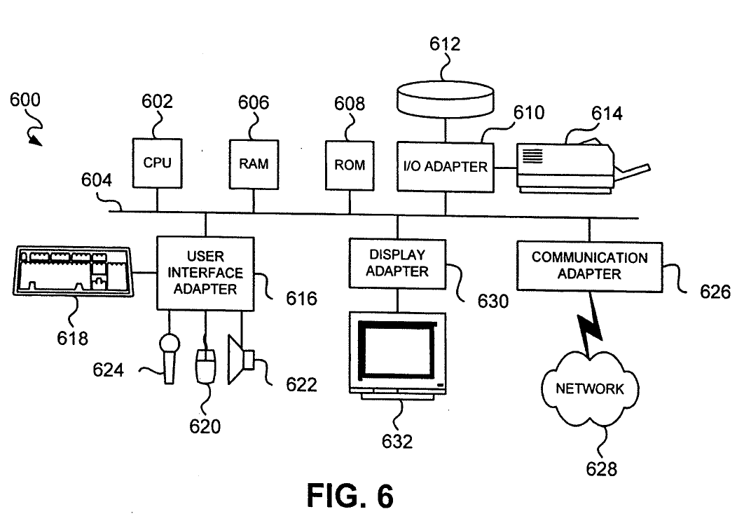

A representative hardware environment associated with the various components of FIG. 5 is depicted in FIG. 6. In the present description, the various sub-components of each of the components may also be considered components of the system. For example, particular software modules executed on any component of the system may also be considered components of the system. In particular, FIG. 6 illustrates an exemplary hardware configuration of a workstation 600 having a central processing unit 602, such as a microprocessor, and a number of other units interconnected via a system bus 604.

The workstation shown in FIG. 6 includes a Random Access Memory (RAM) 606, Read Only Memory (ROM) 608, an I/O adapter 610 for connecting peripheral devices such as, for example disk storage units 612 and printers 614 to the bus 604, a user interface adapter 616 for connecting various user interface devices such as, for example, a keyboard 618, a mouse 620, a speaker 622, a microphone 624, and/or other user interface devices such as a touch screen or a digital camera to the bus 604, a communication adapter 626 for connecting the workstation 600 to a communication network 628 (e.g., a data processing network) and a display adapter 630 for connecting the bus 604 to a display device 632. The workstation may utilize an operating system such as the Microsoft Windows NT or Windows/95 Operating System (OS), the IBM OS/2 operating system, the MAC OS, or UNIX operating system. Those of ordinary skill in the art will appreciate that the present invention may also be implemented on platforms and operating systems other than those mentioned.

As previously mentioned, embodiments of the present invention may also be implemented using computer program languages such as, for example, ActiveX, Java, C, and the C++ language and utilize object oriented programming methodology. Any such resulting program, having computer-readable code, may be embodied or provided within one or more computer-readable media, thereby making a computer program product (i.e., an article of manufacture). The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One of ordinary skilled in the art will easily be able to combine software with appropriate general purpose or special purpose computer hardware to create a computer system or computer sub-system for implementing various embodiments described herein.

Other embodiments of the invention will be apparent to those skilled in the art from consideration of the specification and embodiments disclosed herein. Thus, the specification and examples are exemplary only, with the true scope and spirit of the invention set forth in the following claims and legal equivalents thereof.

What is claimed is:

1. A computer-executable method for analyzing hardware and software components of a computer, the method comprising the steps of:
obtaining system component information regarding system components of a computer;
comparing the obtained system component information to one or more system component requirements stored on a computer-readable medium; and
determining if the system components of the computer meet the system component requirements based on the comparing step.

2. The method according to claim 1 wherein the system component information includes the name of the system components.

3. The method of according to claim 1 wherein the system component information includes features of the system components.

4. The method according to claim 1 wherein the system component information includes hardware component information and/or software component information.

5. The method according to claim 1 wherein the comparing step compares the obtained system component information to system component requirements of a software product.

6. The method according to claim 1 wherein the comparing step compares the obtained system component information to system component requirements of a hardware product.

7. The method according to claim 1 further including the step of:
informing of a degree to which the obtained system components of the computer meet the system component requirements based on the determining step.

8. The method of claim 7 wherein the degree to which the obtained system components of the computer meet the system component requirements includes a failure degree and a pass minimum requirements degree.

9. The method of claim 8 wherein the degree to which the obtained system components of the computer meet the system component requirements further includes a pass recommended requirements degree.

10. The method of claim 1 wherein the system component information is obtained via a computer network.

11. The method of claim 10 wherein the obtaining step is preceded by the step of uploading a program to the computer, the program configured to obtain the system component information.

12. The method of claim 1 wherein:
the obtained system component information includes information concerning one or more system components and the system component requirements include requirements concerning one or more system component types; and
the comparing step compares the information for each system component to a system component requirement that has a corresponding system component type.

13. The method of claim 1 wherein:
the obtained system component information includes information concerning one or more system components and the system component requirements include requirements concerning one or more system component types; and
the comparing step compares an aggregate of the information concerning the one or more system components with an aggregate of the system component requirements concerning the one or more system component types.

14. The method of claim 1 wherein:
the system component requirements include requirements for one or more system component types, the requirements for each system component type comprising a ranked list; and
the comparing step locates where the obtained system component information for a system component fits in the ranked list for its corresponding system component type.

15. The method of claim 14 wherein the ranked list includes a pass level, and wherein the determining step determines that a system component meets the corresponding system component requirement if the comparing step locates the obtained system component information for a system component above the pass level.

16. The method of claim 7 wherein in the case that it is determined that the system components of the computer do not meet the system component requirements, the informing step further informs of how system components that meet the system component requirements may be acquired.

17. A computer-readable medium storing computer-executable code for analyzing hardware and software components of a computer, the computer-executable code comprising:
an obtaining code for obtaining system component information regarding system components of a computer;
a comparing code for comparing the obtained system component information to one or more system component requirements stored on a computer-readable medium; and
a determining code for determining if the system components of the computer meet the system component requirements based on the result of the comparing code.

18. The computer-readable medium according to claim 17 wherein the system component information includes the name of the system components.

19. The computer-readable medium of according to claim 17 wherein the system component information includes features of the system components.

20. The computer-readable medium according to claim 17 wherein the system component information includes hardware component information and/or software component information.

21. The computer-readable medium according to claim 17 wherein the comparing code compares the obtained system component information to system component requirements of a software product.

22. The computer-readable medium according to claim 17 wherein the comparing code compares the obtained system component information to system component requirements of a hardware product.

23. The computer-readable medium according to claim 17 further comprising:
an informing code for informing of a degree to which the obtained system components of the computer meet the system component requirements based on the result of the determining code.

24. The computer-readable medium of claim 23 wherein the degree to which the obtained system components of the computer meet the system component requirements includes a failure degree and a pass minimum requirements degree.

25. The computer-readable medium of claim 24 wherein the degree to which the obtained system components of the computer meet the system component requirements further includes a pass recommended requirements degree.

26. The computer-readable medium of claim 17 wherein the system component information is obtained via a computer network.

27. The computer-readable medium of claim 26 wherein the obtaining code is preceded by an uploading code for uploading a program to the computer, the program configured to obtain the system component information.

28. The computer-readable medium of claim 17 wherein:
the obtained system component information includes information concerning one or more system components and the system component requirements include requirements concerning one or more system component types; and
the comparing code compares the information for each system component to a system component requirement that has a corresponding system component type.

29. The computer-readable medium of claim 17 wherein:
the obtained system component information includes information concerning one or more system components and the system component requirements include requirements concerning one or more system component types; and
the comparing code compares an aggregate of the information concerning the one or more system components with an aggregate of the system component requirements concerning the one or more system component types.

30. The computer-readable medium of claim 17 wherein:
the system component requirements include requirements for one or more system component types, the requirements for each system component type comprising a ranked list; and
the comparing code locates where the obtained system component information for a system component fits in the ranked list for its corresponding system component type.

31. The computer-readable medium of claim 30 wherein the ranked list includes a pass level, and wherein the determining code determines that a system component meets the corresponding system component requirement if the comparing code locates the obtained system component information for a system component above the pass level.

32. The computer-readable medium of claim 23 wherein in the case that it is determined that the system components of the computer do not meet the system component requirements, the informing code further informs of how system components that meet the system component requirements may be acquired.
